(19) United States
(12) Patent Application Publication
(10) Pub. No.: US 2019/0011478 A1
(43) Pub. Date: Jan. 10, 2019

(54) OBSERVATION METHOD USING COMPOUND MICROSCOPE INCLUDING AN INVERTED OPTICAL MICROSCOPE AND ATOMIC FORCE MICROSCOPE, PROGRAM TO PERFORM OBSERVATION METHOD, AND COMPOUND MICROSCOPE

(71) Applicant: OLYMPUS CORPORATION, Tokyo (JP)

(72) Inventors: Yoshitsugu UEKUSA, Tachikawa-shi (JP); Nobuaki SAKAI, Hachioji-shi (JP)

(73) Assignee: OLYMPUS CORPORATION, Tokyo (JP)

(21) Appl. No.: 16/111,491

(22) Filed: Aug. 24, 2018

Related U.S. Application Data
(63) Continuation of application No. PCT/JP2016/055889, filed on Feb. 26, 2016.

(51) Int. Cl. G01Q 30/02; G01N 21/64; G02B 21/02; G02B 21/36; G02B 21/00

(52) U.S. Cl. CPC G01Q 30/025; G01N 21/6458; G02B 21/0076; G02B 21/368; G02B 21/02

(57) ABSTRACT

An observation method using a compound microscope of an inverted optical microscope and an atomic force microscope includes scanning a cantilever so that a probe approaches a sample until surface layer information is acquired, observing the cantilever through the optical microscope to acquire shape information of the cantilever, moving an observation position of the optical microscope downward based on a length of the probe, performing fluorescence observation through the optical microscope, and scanning the cantilever to acquire the surface layer information. The probe approach, cantilever observation, and observation position movement are performed in order. The fluorescence observation is performed after the observation position movement. The surface layer information acquisition is performed after the probe approach.

### CROSS-REFERENCE TO RELATED APPLICATIONS

This application is a Continuation Application of PCT Application. No. PCT/JP2016/055889, filed Feb. 26, 2016, the entire contents of which are incorporated herein by reference.

### BACKGROUND OF THE INVENTION

### 1. Field of the Invention

The present invention relates to an observation method using a compound microscope including an inverted optical microscope and an atomic force microscope.

### 2. Description of the Related Art

A compound microscope is a microscope system combining at least two types of microscopes that acquire different physical information. A representative example thereof is a compound microscope combining an optical microscope that performs fluorescence observation and an atomic force microscope that observes a fine shape of a sample surface layer. This compound microscope has an advantage of being capable of acquiring a spatiotemporal correlation between fluorescent information and sample surface layer information of the same sample.

For an optical microscope of such a compound microscope, for example, a super-resolution microscope in which resolution along a Z-axis (hereinafter referred to as “Z-resolution”) is improved by reducing light other than fluorescent light emitted from a focal position (such as a confocal microscope, STED, and STORM) may be used. Z-resolution of a confocal microscope is 500 nm to 1000 nm, and a super-resolution microscope in recent years has realized Z-resolution of 100 nm or less.

A conventional example of such a compound microscope is disclosed in, for example, “Impact of Actin Rearrangement and Degranulation on the Membrane Structure of Primary Mast Cells: A Combined Atomic Force and Laser Scanning Confocal Microscopy investigation” (Biophysical Journal Volume 96, February 2009, 1629-1639).

### BRIEF SUMMARY OF THE INVENTION

The present invention is directed to, in an aspect, an observation method using a compound microscope including an inverted optical microscope that performs at least fluorescence observation from below a sample and an atomic force microscope that acquires sample surface layer information from above the sample. The compound microscope has a Z-axis extending in up and down directions The inverted optical microscope includes a stage on which a transparent substrate holding the sample is placed, an objective lens arranged below the stage, and an objective lens driving actuator that drives the objective lens along the Z-axis. The atomic force microscope includes a cantilever arranged above the stage and having a probe at the free end, and a Z-scanning actuator that scans the cantilever along the Z-axis. The observation method includes scanning the cantilever along the Z-axis so that the probe approaches a sample surface layer until the sample surface layer information can be acquired, observing the cantilever through the inverted optical microscope to acquire at least shape information of the cantilever, moving an observation position of the inverted optical microscope downward along the Z-axis based on at least a length of the probe, performing fluorescence observation through the inverted optical microscope, and scanning the cantilever at least along the Z-axis to acquire the sample surface layer information. The approach of the probe, the observation of the cantilever, and the movement of the observation position are performed in order. The observation of the fluorescence observation is performed after the movement of the observation position. The acquisition of the sample surface layer information is performed after the approach of the probe.

Advantages of the invention will be set forth in the description which follows, and in part will be obvious from the description, or maybe learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiment of the invention, and together with the general description given above and the detailed description of the embodiments given below, serve to explain the principles of the invention.

FIG. 1 shows a compound microscope according to a first embodiment.

FIG. 2 schematically shows the vicinity of a sample surface layer observed through the compound microscope.

FIG. 3 shows a flow of steps of the observation method of the first embodiment.

FIG. 4 schematically shows the vicinity of the sample surface layer observed through the compound microscope shown in FIG. 1.

FIG. 5 schematically shows the vicinity of the sample surface layer observed through the compound microscope shown in FIG. 1, and shows a state in which a cantilever is included within a Z-resolution width (Z-observation width) and a state in which the tip of a probe and the surface layer of the sample are included within the Z-resolution width (Z-observation width).

FIG. 6 shows a compound microscope according to a second embodiment.

FIG. 7 shows a flow of steps of an observation method of the second embodiment.

FIG. 8 schematically shows the vicinity of a sample surface layer observed through the compound microscope shown in FIG. 6, and shows both a state immediately after an observation position movement step and also a state following a lapse of time.

FIG. 9 shows a compound microscope according to a third embodiment.

FIG. 10 shows a flow of steps of an observation method of the third embodiment.

FIG. 11 shows a sample and an observation area of the sample.

FIG. 12 shows a state in which fluorescent information and sample surface layer information are overlaid, and displayed on a monitor.

FIG. 13 shows a state in which the fluorescent information and the sample surface layer information are overlaid by using shape information of a cantilever as a positional reference, and displayed on the monitor.

FIG. 14 schematically shows the vicinity of a sample surface layer observed through the compound microscope, and shows a state in which fluorescently-labeled substances exist only at the bottom of the sample.

FIG. 15 schematically shows the vicinity of the sample surface layer observed through the compound microscope, and several positions of a Z-resolution width (Z-observation width).

### DETAILED DESCRIPTION OF THE INVENTION

### First Embodiment

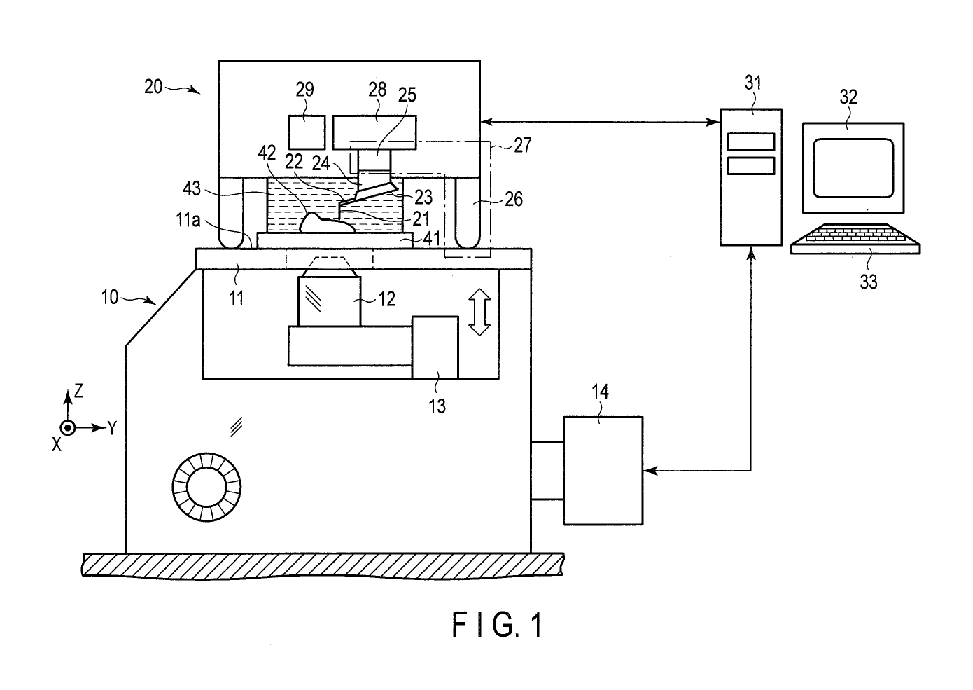

A first embodiment will be described below with reference to FIGS. 1 to 5. FIG. 1 shows a compound microscope according to the present embodiment.

The compound microscope shown in FIG. 1 includes an inverted optical microscope 10 that performs fluorescence observation in at least a sample 42 and a solution 43 from below the sample, an atomic force microscope 20 that acquires information of a surface layer of the sample 42 (sample surface layer information) from above the sample, and a controller 31 that controls the compound microscope. The inverted optical microscope 10 is constituted by either a confocal microscope or a super resolution microscope. The compound microscope also includes a monitor 32 for performing display of observation results and the like, and an input device 33 for performing input of instructions and the like.

The compound microscope has an X-axis, a Y-axis, and a Z-axis. The Z-axis extends in up and down directions, that is, in the vertical direction. The X-axis is orthogonal to the Z-axis. The Y-axis is orthogonal to both of the X-axis and the Z-axis.

The inverted optical microscope 10 includes a stage 11 on which a transparent substrate 41 holding the sample 42 is placed, an objective lens 12 arranged below the stage 11, an objective lens driving actuator 13 that drives the objective lens 12 along the Z-axis, and an imaging unit 14 such as a CCD camera. More precisely, the stage 11 has a placement surface to be in contact with a substrate 41, and the objective lens 12 is arranged below the placement surface 11a of the stage 11.

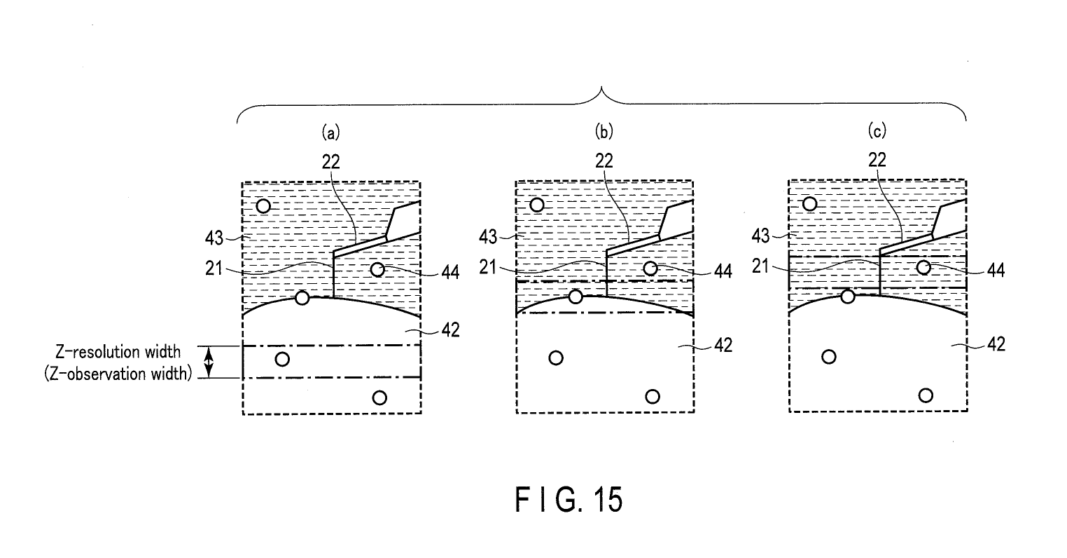

The objective lens driving actuator 13 that drives the objective lens 12 along the Z-axis is controlled by the controller 31, so that the position of the Z-resolution width (Z-observation width) may be freely set along the Z-axis as shown in (a), (b), and (c) of FIG. 15, for example.

The fluorescent information acquired by the inverted optical microscope 10 is information that can be acquired by the inverted optical microscope 10, including information on fluorescent substances such as fluorescent dyes of low-molecular organic compounds and fluorescent proteins such as GFP in observation of cells, and information on caged compounds and autofluorescence, for example.

As the inverted optical microscope 10, for example, confocal microscope or a super-resolution microscope such as STED or STORM, in which resolution along the Z -axis (hereinafter referred to as Z-resolution) is improved by reducing light other than fluorescent light emitted from a focal position, is used. Z-resolution of the confocal microscope is 500 nm to 1000 nm, and Z-resolution of the super-resolution microscope achieves 100 nm or less at a maximum.

The atomic force microscope 20 is mounted on the inverted optical microscope 10. The atomic force microscope 20 includes a cantilever 22 arranged above the stage 11 and having a probe 21 at the free end, a Z-piezoelectric element 25 that finely scans the cantilever 22 along the Z-axis, and a Z-coarse adjustment actuator 26 that coarsely scans the cantilever 22 scan along the Z-axis. The cantilever 22 is supported in a cantilevered manner by a support 23, and the support 23 is attached to the Z-piezoelectric element 25 through a holder 24. The Z-piezoelectric element 25 and the Z-coarse adjustment actuator 26 constitute a Z-scanning actuator 27 that scans the cantilever 22 along the Z-axis by courtesy of both of the Z-piezoelectric element 25 and the Z-coarse adjustment actuator 26. The atomic force microscope 20 also includes an XY-scanning actuator 28 that scans the cantilever 22 along the X-axis and the Y-axis, and a displacement sensor 29 that detects displacement of the cantilever 22.

A curvature radius of the tip of the probe 21 is 10 nm or less, which is so thin that the tip cannot be observed even with a super-resolution microscope.

The Z-piezoelectric element 25 and the XY-scanning actuator 28 may be configured using a tube scanner, or may be configured using the scanning mechanism of Jpn. Pat. Appln. KOKAI Publication No. 2014-35252, for example.

The Z-scanning actuator 27 is controlled by the controller 31, and scans the cantilever 22 along the Z-axis in accordance with a scanning signal (not shown) supplied from the controller 31.

Scanning the cantilever 22 along the Z-axis as described herein includes not only dynamically or statically displacing the cantilever 22 along the Z-axis but also maintaining the cantilever 22 in a displaced state.

Accordingly, the Z-scanning actuator 27 scans the cantilever 22 along the Z-axis in accordance with a Z-scanning signal supplied from the controller 31, so as to allow the distance along the Z-axis between the tip of the probe 21 and the surface layer of the sample 42 to be changed. It also allows the distance to be maintained.

The displacement sensor 29 outputs a displacement signal indicating the displacement of the cantilever 22 to the controller 31. The controller 31 acquires sample surface layer information based on the input displacement signal.

The sample surface layer information acquired by the atomic force microscope 20 is, for example, information on a physical interaction occurring between the sample and the probe, such as an uneven shape of the sample, viscoelasticity information, and electrical information. For example, the information on the uneven shape of the sample is image information of the sample surface layer acquired by XY-scanning Z-scanning the cantilever 22, and the viscoelasticity information is the information on the force acting between the probe 21 and the sample 42 acquired by only Z-scanning without XY-scanning the cantilever 22.

The transparent substrate 41 holding the sample 42 is placed on the stage 11 of the inverted optical microscope 10. For example, the stage 11 includes an XY stage (not shown), and the substrate 41 is placed on this XY stage. The sample 42, the probe 21, and the cantilever 22 are surrounded by the solution 43 held by the substrate 41.

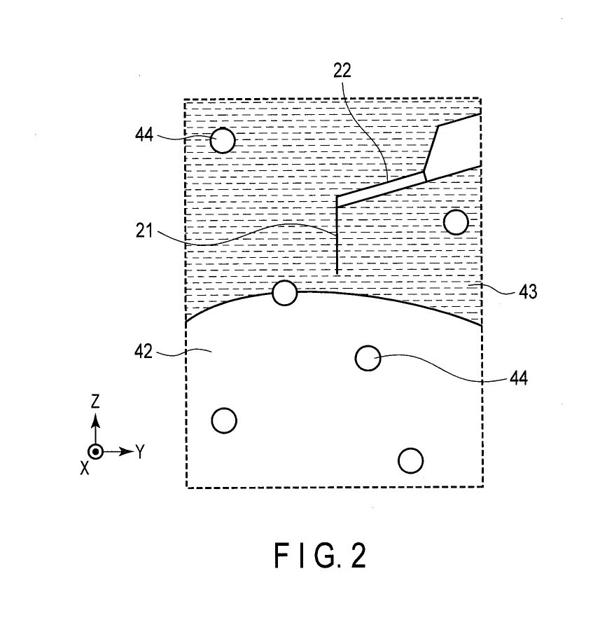

FIG. 2 schematically shows a view of the vicinity of the sample surface layer observed through the compound microscope, as viewed from an X-axis positive direction. The sample 42 is, for example, a living cell, fluorescently-labeled substances 44 are, for example, fluorescently-labeled viruses, and it is assumed that the viruses are scattered inside and outside the cell.

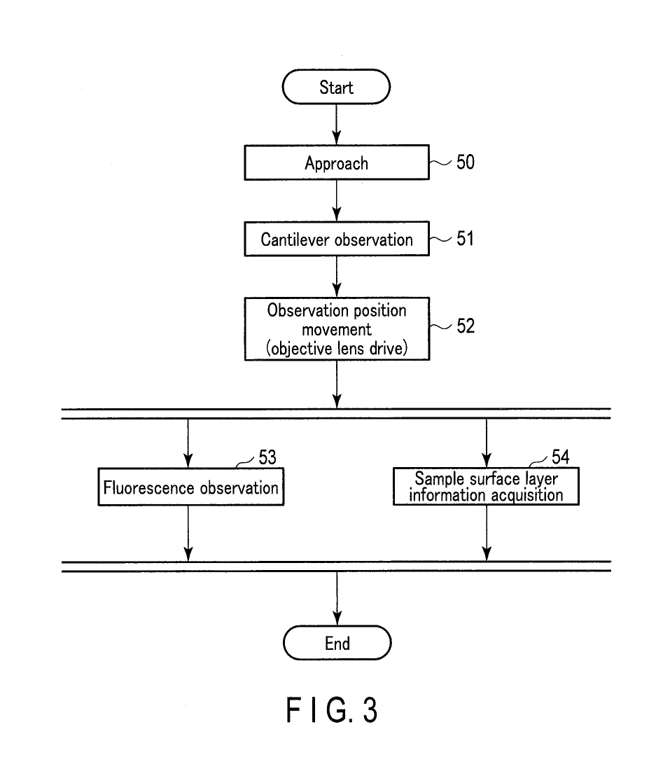

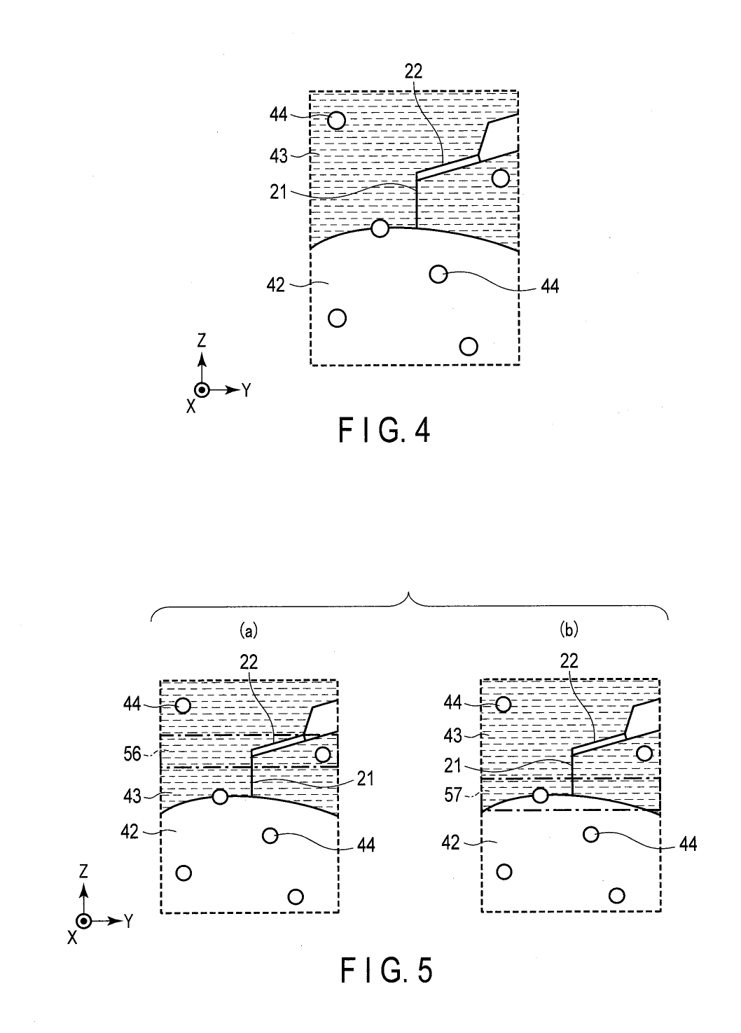

Next, a flow of operation (steps of an observation method) of the compound microscope of the present embodiment with the above constitution will be described using FIGS. 3 to 5. FIG. 3 shows a flow of steps of an observation method of the present. embodiment. FIGS. 4 and 5 schematically show the vicinity of the sample surface layer observed through the compound microscope.

In the approaching step 50, the cantilever 22 is scanned along the Z-axis by causing the Z -scanning actuator 27 to extend and contract, specifically, by causing the Z-piezoelectric element 25 constituting the Z-scanning actuator 27 to extend or by causing the Z-coarse adjustment actuator 26 to contract, or by both, so that the tip of the probe 21 approaches the surface layer of the sample 42 until the interaction between the tip of the probe 21 and the surface layer of the sample 42 occurs, that is, the sample surface layer information can be acquired, as shown in FIG. 4.

In the next cantilever observation step 51, the cantilever 22 is observed through the inverted optical microscope 10 to acquire shape information of the cantilever 22. Preferably, the root portion of the probe 21 is observed to acquire shape information of the root portion of the cantilever 22. In this cantilever observation step 51, the cantilever 22 is observed by fluorescence observation of autofluorescence of the cantilever 22 or bright-field observation. In this cantilever observation step 51, the objective lens 12 is driven along the Z-axis by the objective lens driving actuator 13 to set the position of the Z-resolution width (Z-observation width) along the Z-axis to the position of a Z-resolution width (Z-observation width) 56 shown in (a) of FIG. 5. The cantilever 22 is included in the Z-resolution width (Z-observation width) 56.

In the next observation position movement step 52, the observation position of the inverted optical microscope 10, that is, the position of the Z-resolution width (Z-observation width) is moved in the downward direction of the sample 42 along the Z-axis based on at least the length of the probe 21, by a distance equal to the length of the probe 21, for example. As a result, the position of the Z-resolution width (Z-observation width) is set to the position of a Z-resolution. width (Z-observation width) 57 shown in (b) of FIG. 5. The tip of the probe 21 and the surface layer of the sample 42 are included within the Z-resolution width (Z-observation width) 57.

In this observation position movement step 52, the position of the Z-resolution width (Z-observation width) 57 is moved by driving the objective lens 12 by the objective lens driving actuator 13. The drive amount may be set simply based on the length of the probe 21. However, the drive amount is preferably set based on, for example, the length of the probe 21, the refractive index of the solution 43, and the refractive index of immersion oil if an oil immersion objective lens is used as the objective lens 12.

The objective lens 12 is driven by a method of driving the entire unit including the exterior of the objective lens 12, or by a method of driving at least one lens inside the objective lens 12. In the case of using a liquid immersion objective lens such as an oil immersion objective lens, a water immersion objective lens, or a silicone immersion objective lens, if the entire unit of the objective lens 12 is driven, the operation may generate, through the liquid, vibration noise on the substrate 41 on which the sample 42 is placed. Thus, the method of driving at least one lens inside the objective lens 12 is preferable. In this method, the exterior of the objective lens 12 does not move, and thus the influence of the vibration noise on the substrate 41 is reduced. Furthermore, a constitution of a microscope capable of moving a focus without changing a distance between an objective lens and a sample, which is disclosed in Jpn. Pat. Appln. KOKAI Publication No. 2005-10516, may be used.

Through the above three steps, the position of the Z-resolution width (Z-observation width) can be set to the surface layer of the sample 42, as shown in (b) of FIG. 5.

Then, a fluorescence observation step 53 and a sample surface layer information acquisition step 54 are performed.

In the fluorescence observation step 53, fluorescence observation in the sample 42 and the solution 43 is performed through the inverted optical microscope 10.

In the sample surface layer information acquisition step 54, the atomic force microscope 20 scans at least the cantilever 22 alone the Z-axis to acquire information on the surface layer of the sample 42, which is the sample surface layer information.

The fluorescence observation step 53 and the sample surface layer information acquisition step 54 may be performed in order, but are preferably performed at the same time if it is desired to acquire time-variable positional correlation.

The start of the sample surface layer information acquisition step 54 is not limited to taking place after the observation position movement step 52. For example, the start of the sample surface layer information acquisition step 54 may be taken place immediately after the approaching step 50 if the functions of the cantilever observation step 51 and the observation position movement step 52 are not disturbed.

In other words, the approaching step 50, the cantilever observation step 51, and the observation position movement step 52 are performed in order, and the fluorescence observation step 53 is performed after performing the approaching step 50, the cantilever observation step 51, and the observation position movement step 52 in order; however, the sample surface layer information acquisition step 54 is performed after the approaching step SO . The sample surface layer information acquisition step 54 is preferably performed after the the observation position movement step 52.

In order to perform the above steps, a program to perform the observation method is installed in the controller 31.

By performing the observation method of the present embodiment, the fluorescent information in the vicinity of a surface layer of a sample 42 of which layer information is acquired by an atomic force microscope 20 can be correctly acquired. As a result, accurate positional correlation between sample surface layer information and the fluorescent information can be acquired.

In the present embodiment, a curvature radius of the tip of a probe is 10 nm or less, and the tip of the probe is so thin that the tip cannot be observed even with a super-resolution microscope; thus, a position of a Z-resolution width (Z-observation width) is set to the surface layer of the sample 42 by firstly bringing the tip of a probe 21 close to the surface layer of the sample 42 by an approaching step 50, secondly observing a cantilever 22 by a cantilever observation step 51, and lastly moving the position of the Z-resolution width (Z-observation width) of an inverted optical microscope 10 based on the length of the probe 21 by an observation position movement step 52.

The highest accuracy is achieved by using the cantilever 22, preferably the root portion of the probe 21 of the cantilever 22, as a positional reference of the Z -resolution width (Z-observation width).

### Second Embodiment

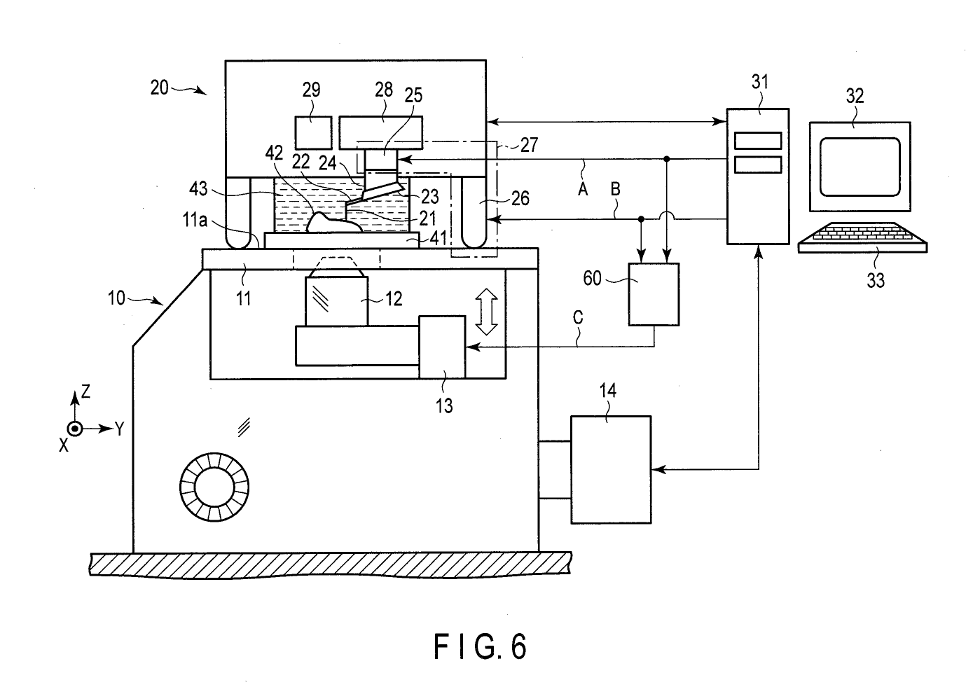

The present embodiment will be described below with reference to FIGS. 6 to 8. FIG. 6 shows a compound microscope according to the present embodiment. In FIG. 6, the members denoted by the same reference numerals as the members shown in FIG. 1 are the same members, and detailed descriptions thereof will be omitted.

In the compound microscope shown in FIG. 6, a follow-up control controller 60 is added to the compound microscope shown in FIG. 1.

A scanning signal A for fine movement, which is output from a controller 31, is supplied to a Z-piezoelectric element. 25, and a scanning signal B for coarse movement, which is output from the controller 31, is supplied to a Z-coarse adjustment actuator 25. In other words, the scanning signal composed of both of the scanning signal A and the scanning signal B, which are output from the controller 31, is supplied to a Z-scanning actuator 27 constituted by the Z-piezoelectric element 25 and the Z-coarse adjustment actuator 26.

The Z-scanning actuator 27 is controlled by the controller 31, and scans a cantilever 22 along the Z-axis in accordance with the scanning signal supplied from the controller 31.

Scanning the cantilever 22 along the Z-axis as described herein includes not only dynamically or statically displacing the cantilever 22 along the Z-axis but also maintaining the cantilever 22 in a displaced state.

Accordingly, the Z-scanning actuator 27 scans the cantilever 22 along the Z-axis in accordance with the scanning signal supplied from the controller 31, so as to allow the distance along the Z-axis between the tip of the probe 21 and the surface layer of a sample 42 to be changed. It also allows the distance to be maintained.

The scanning signal A and the scanning signal B respectively supplied to the Z-piezoelectric element 25 and the Z-coarse adjustment actuator 26, namely the scanning signal supplied to the Z-scanning actuator 27, are also supplied to a follow-up control controller 60.

The follow-up control controller 60 controls the objective lens driving actuator 13 so that an objective lens 12 is driven to follow up the scanning of the cantilever 22 along the Z-axis.

Specifically, the follow-up control controller 60 controls the objective lens driving actuator 13 based on the scanning signal composed of the scanning signal. A and the scanning signal B.

This follow-up control controller 60 generates a driving signal C based on the scanning signal composed of the scanning signal A and the scanning signal B, and supplies the driving signal C to the objective lens driving actuator 13.

Specifically, the follow-up control controller 60 first obtains the amount of expansion and contraction of the Z-piezoelectric element 25 and the Z-coarse adjustment actuator 26 from the supplied scanning signal A and scanning signal B, respectively. Next, the controller obtains the displacement amount of the cantilever 22 along the Z-axis based on the amount of extension and contraction of the Z-piezoelectric element 25 and the amount of expansion and contraction of the Z-coarse adjustment actuator 26. Furthermore, the controller obtains a drive amount of the objective lens 12 from the displacement amount of the cantilever 22 along the Z-axis. Then, the controller obtains generates the driving signal C based on the displacement amount, to supply to the objective lens driving actuator 13.

The drive amount of the objective lens driving actuator 13 is obtained based on, for example, the length of the probe 21, the refractive index of the sample 42, and the refractive index of immersion oil if an oil immersion objective lens is used as the objective lens 12.

In addition to the control of the objective lens driving actuator 13 by the follow-up control controller 60 based on the scanning signal, several variation are possible. For example, a displacement sensor maybe provided in the Z-scanning actuator 27, and the objective lens driving actuator 13 may be controlled based on information of the scanning amount (equal to the displacement amount of the cantilever 22) of the Z-scanning actuator 27 acquired by the displacement sensor.

Furthermore, the follow-up control controller 60 may be built in the controller 31 of the compound microscope.

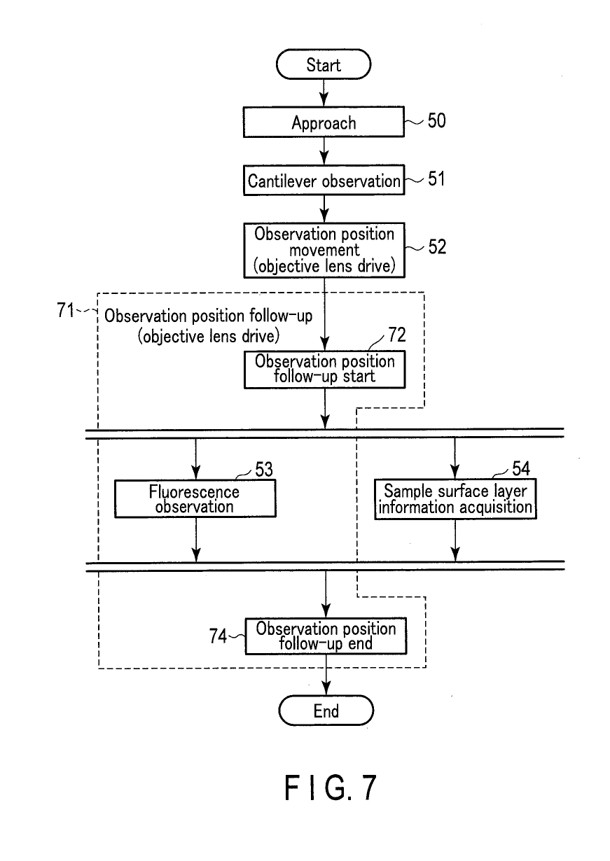

FIG. 7 shows a flow of steps of an observation method of the present embodiment The observation method of the present embodiment includes an observation position follow-up step 71 in addition to the steps in the observation method described in the first embodiment and shown in FIG. 3.

The observation position follow-up step 71 includes an observation position follow-up start step 72, a fluorescence observation step 53, and an observation position follow-up end step 74. In other words, the observation position follow-up step 71 includes a fluorescence observation step 53.

In the observation position follow-up step 71, the observation position of the inverted optical microscope 10 along the Z-axis is moved so as to follow up the scanning of the cantilever 22 along the Z-axis. In other words, the objective lens driving actuator 13 drives the objective lens 12 so that the objective lens 12 follows up the scanning of the cantilever 22 along the Z-axis.

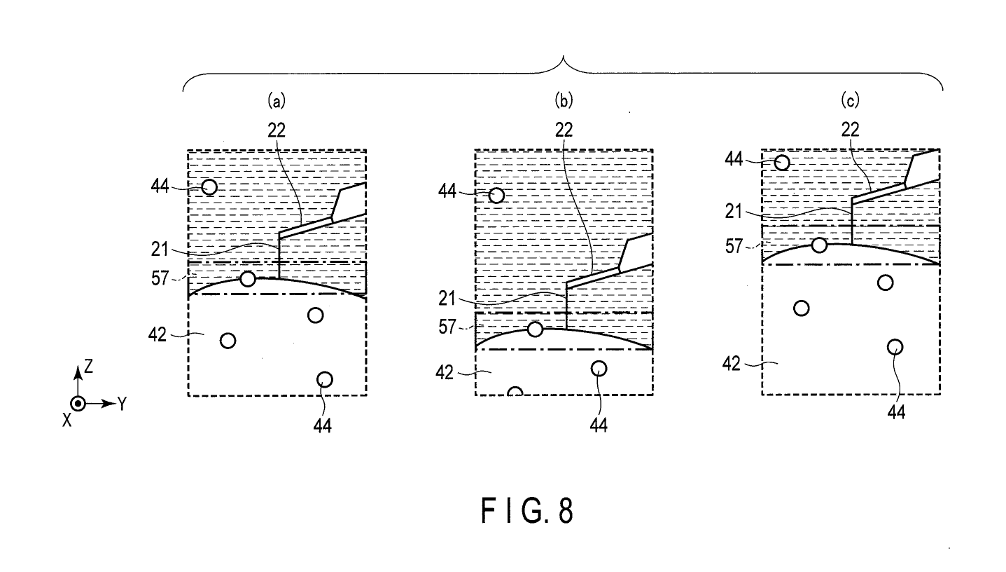

In the observation method of the present embodiment, the steps described below are performed following the observation position movement step 52 of FIG. 3 described in the first embodiment. Item (a) of FIG. 8 shows a state immediately after the observation position movement step 52.

The observation position follow-up step 71 is started between the observation position movement step 52 and the fluorescence observation step 53. In other words, an observation position follow-up start step 72 is performed between the observation position movement step 52 and the fluorescence observation step 53.

After the observation position follow-up start step 72 is started, the sample surface layer information acquisition step 54 and the fluorescence observation step 53 are started.

In the sample surface layer information acquisition step 54, an atomic force microscope 20 scans at least the cantilever 22 along the Z-axis to acquire information on the surface layer of the sample 42, which is sample surface layer information.

In the fluorescence observation step 53, fluorescence observation in the sample 42 arid the solution 43 is performed through the inverted optical microscope 10.

The sample surface layer information acquisition step 54 and the fluorescence observation step 53 are preferably performed at the same time if it is desirable to acquire time-variable positional correlation.

The start of the sample surface layer information acquisition step 54 is not limited to taking place after the observation position movement step 52. For example, the start of the sample surface layer information acquisition step 54 may be taken place immediately after the approaching step 50 if the functions of the cantilever observation step 51 and the observation position movement step 52 are undisturbed.

After the sample surface layer information acquisition step 54 and the fluorescence observation step 53 are ended, the observation position follow-up step 71 is ended. In other words, the observation position follow-up end step 74 is performed.

In order to perform the above steps, a program to perform the observation method is installed in the controller 31.

As understood from the above description, the same advantageous effect as the first embodiment can be obtained in the present embodiment. In other words, the fluorescent information in the vicinity of the surface layer of the sample 42 acquired by the atomic force microscope 20 can be correctly acquired. As a result, accurate positional correlation between the sample surface layer information and the fluorescent information can be acquired.

Furthermore, the present embodiment has the following advantageous effect e For example, in the case where the sample 42 is a living cell and the position of its surface layer along the Z-axis changes from (a) to (b) and (c) of FIG. 8 over time, the fluorescent information in the vicinity of the surface layer of the sample 42 cannot be correctly acquired if the observation position follow-up step 71 is not performed. In the present embodiment, since on the other hand, the observation position follow-up step 71 is performed, the fluorescent information in the vicinity of the surface layer of the sample 42 can be correctly acquired even if the position of the surface layer of the sample 42 along the Z-axis temporally changes beyond a Z-resolution width (Z-observation width) 57.

### Third Embodiment

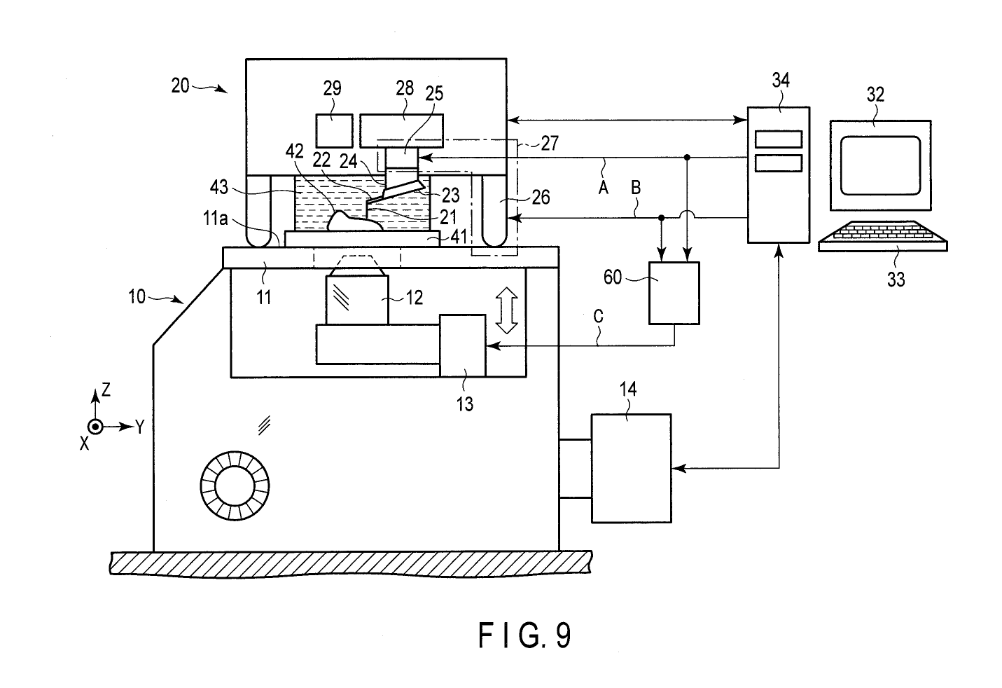

A third embodiment will be described below with reference to FIGS. 9 to 12. FIG. 9 shows a compound microscope according to the present embodiment. In FIG. 9, the members denoted by the same reference numerals as the members shown in FIG. 6 are the same members, and detailed descriptions thereof will be omitted.

The compound microscope of the present embodiment is different from the compound micros cope of the second embodiment shown in FIG. 6 only in the controller. The compound microscope of the present embodiment shown in FIG. 9 includes a controller 34 in place of the controller 31 of the second embodiment.

The controller 34 performs image processing of overlaying sample surface layer information and fluorescent information. A monitor 32 displays an image in which the sample surface layer information and the fluorescent information are overlaid.

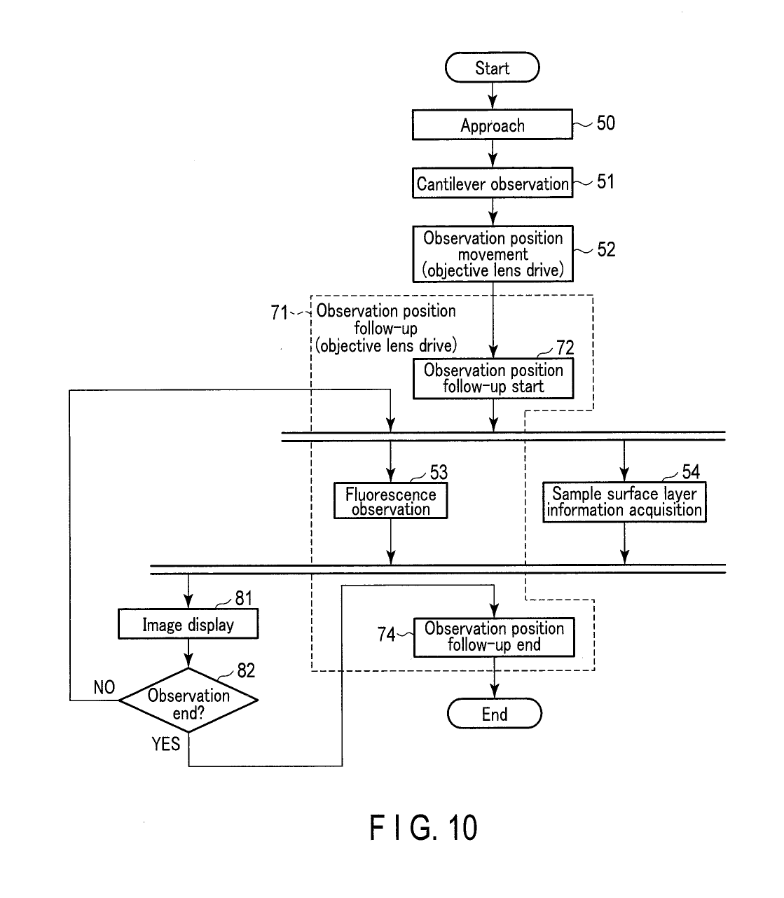

FIG. 10 shows a flow of steps of an observation method of the present embodiment. The observation method of the present embodiment includes an image display step 81 and an observation end step 82 in addition to the steps in the observation method described in the second embodiment and shown in FIG. 7.

In the image display step 81, the sample surface layer information acquired in the sample surface layer information acquisition step 54 and the fluorescent information acquired in the fluorescence observation step 53 are overlaid and displayed on the monitor 32.

The image display step 81 is performed after the sample surface layer information acquisition step 54 and the fluorescence observation step 53 are ended, and before the observation position follow-up end step 74.

The respective information acquired in the sample surface layer information acquisition step 54 and the fluorescence observation step 53 may be in any kind of units; for example, line units, image units, or video units. In the present embodiment, the respective information will be described as being in image units.

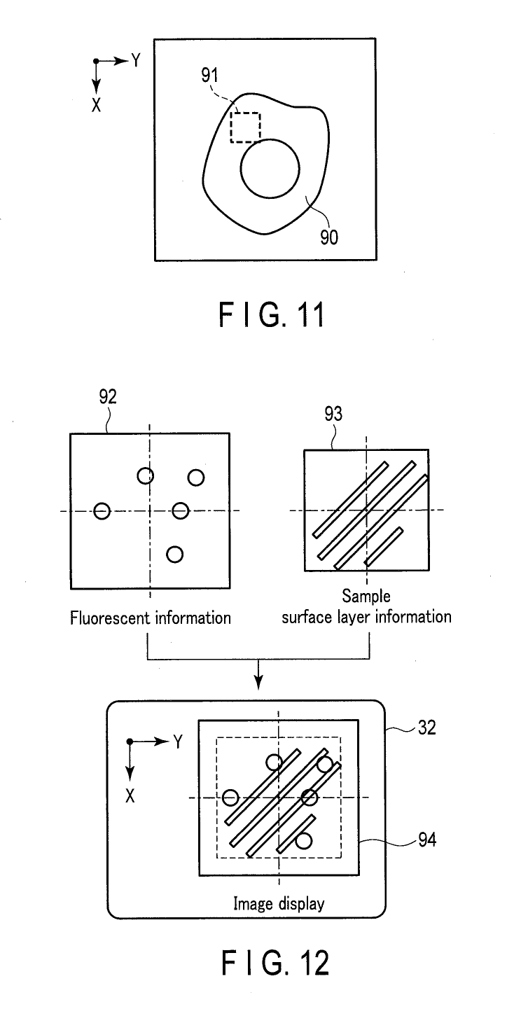

In the image display step 81, for example, if an area 91 of a sample 90 is observed as shown in FIG. 11, an image 94 in which fluorescent information 92 and sample surface layer information 93 are overlaid is displayed on the monitor 32 as shown in FIG. 12.

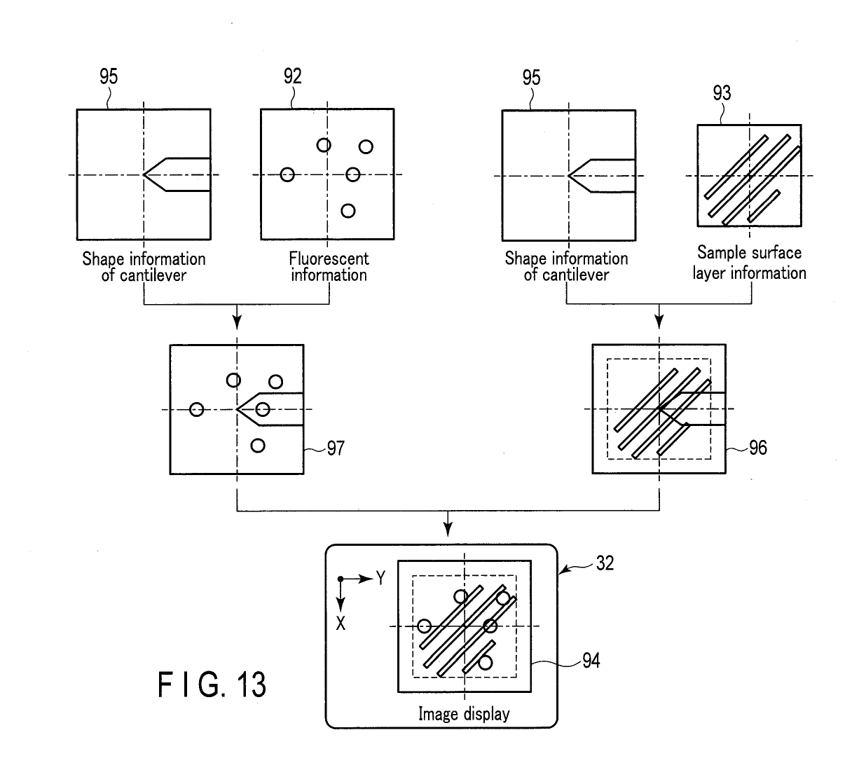

In the image display step 81, the fluorescent information 92 and the sample surface layer information 93 may be overlaid and displayed on the monitor 32 by using shape information. 95 of the cantilever 22 acquired in the cantilever observation step 51 as a positional reference on an XY-plane perpendicular to the Z-axis, as shown in FIG. 13. Specifically, a reference position 97 of the fluorescent information 92 maybe determined by overlaying the shape information. 95 of the cantilever 22 and the fluorescent information 92, a reference position 96 of the sample surface layer information 93 may be determined by overlaying the shape information 95 of the cantilever 22 and the sample surface layer information 93, and an overlaid image of the fluorescent information 92 and the sample surface layer information. 93 may be generated by using the reference position 97 and the reference position 96 and displayed on the monitor 32.

In the observation end step 82, it is determined whether or not the observation is ended. If the observation is not ended here, the process returns to the fluorescence observation step 53 and the sample surface layer information acquisition step 54. If the observation is ended here, the process proceeds to observation position follow-up end step 74.

In order to perform the above steps, a program to perform the observation method is installed in the controller 34.

As understood from the above description, in the present embodiment, since the fluorescent information 92 and the sample surface layer information 93 are overlaid and displayed, more accurate positional correlation between the sample surface layer information and the fluorescent information can be acquired.

The advantageous effect of the present invention is not limited to the case where the fluorescently-labeled substances 44 exist both inside and outside the sample 42 as shown in FIG. 2. In the present invention, the same advantageous effect can be obtained even in the case where the fluorescently-labeled substances 44 exist only inside the sample 42.

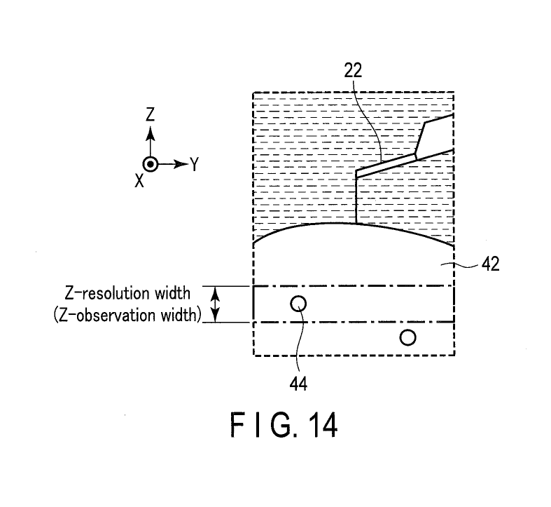

For example, as shown in FIG. 14, if the fluorescently-labeled substances 44 do not exist in the vicinity of the surface layer of the sample 42 but exist only at the bottom portion of the sample 42, the inverted optical microscope 10 inevitably acquires fluorescent information of the bottom portion of the sample 42 when attempting to acquire fluorescent information, without following the present invention. In other words, the inverted optical microscope 10 acquires fluorescent information at a position along the Z-axis that is largely deviated from the surface layer of the sample 42 observed by the atomic force microscope 20 (to the extent that the positional correlation cannot be discussed).

The fluorescent information to be acquired in this case is that “the fluorescently-labeled substances 44 do not exist in the sample surface layer,” and this is the correct fluorescent information. However, this correct fluorescent information cannot be acquired with the conventional compound microscope Furthermore, the most important problem is that the conventional compound microscope “cannot recognize that the fluorescent information at a position along the Z-axis that is largely deviated is acquired.”

In the present invention, the position of the Z-resolution width (Z-observation width) of the inverted optical microscope 10 is aligned with the surface layer of the sample 42 regardless of presence or absence of the fluorescently-labeled substances 44. Therefore, the present invention can also solve such a problem.

The advantageous effect of the present invention is not limited to the case where the sample 42 exists in the solution 43. For example, in “the case where the fluorescently-labeled substances 44 exist only inside the sample 42” described above, the advantageous effect is obtained even if the sample 42 exists in the atmosphere.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An observation method using a compound microscope including an inverted optical microscope that performs at least fluorescence observation from below a sample and an atomic force microscope that acquires sample surface layer information from above the sample,
the compound microscope having a Z-axis extending in up and down directions,
the inverted optical microscope comprising a stage on which a transparent substrate holding the sample is placed, an objective lens arranged below the stage, and an objective lens driving actuator that drives the objective lens along the Z-axis,
the atomic force microscope comprising a cantilever arranged above the stage and having a probe at a free end thereof and a Z-scanning actuator that scans the cantilever along the Z-axis,
the observation method comprising:
scanning the cantilever along the Z-axis so that the probe approaches a sample surface layer until the sample surface layer information can be acquired;
observing the cantilever through the inverted optical microscope to acquire at least shape information of the cantilever;
moving an observation position of the inverted optical microscope downward along the Z-axis based on at least a length of the probe;
performing fluorescence observation through the inverted optical microscope; and
scanning the cantilever at least along the Z-axis to acquire the sample surface layer information,
the approach of the probe, the observation of the cantilever, and the movement of the observation position being performed in order,
the observation of the fluorescence observation being performed after the movement of the observation position, and
the acquisition of the sample surface layer information being performed after the approach of the probe.

2. The observation method according to claim 1, wherein the movement of the observation position includes driving the objective lens.

3. The observation method according to claim 1, wherein the acquisition of the sample surface layer information is performed after the movement of the observation position.

4. The observation method according to claim 1, further comprising moving the observation position of the inverted optical microscope along the Z-axis so that the observation position follows the scanning of the cantilever along the Z-axis, the follow-up of the observation position including the observation of the fluorescence observation, the follow-up of the observation position being started between the movement of the observation position and the observation of the fluorescence observation.

5. The observation method according to claim 4, wherein at least one of the movement of the observation position and the follow-up of the observation position includes driving the objective lens.

6. The observation method according to claim 1, further comprising displaying an image by overlaying the sample surface layer information acquired in the acquisition of the sample surface layer information and fluorescent information acquired in the observation of the fluorescence observation.

7. The observation method according to claim 6, wherein the displaying overlays the fluorescent information and the sample surface layer information are overlaid by using the shape information of the cantilever acquired in the observation of the cantilever as a positional reference on an XY-plane perpendicular to the Z-axis.

8. The observation method according to claim 1, wherein the inverted optical microscope is one of a confocal microscope and a super-resolution microscope.

9. A program for performing the observation method according to claim 1.

10. The compound microscope in which the program according to claim 9 is installed.

11. A compound microscope including an inverted optical microscope that performs at least fluorescence observation and an atomic force microscope that acquires sample surface layer information, having a Z-axis extending in up and down directions, and comprising:
a stage on which a transparent substrate holding a sample is placed;
an objective lens arranged below the stage;
an objective lens driving actuator that drives the objective lens along the Z-axis;
a cantilever arranged above the stage and having a probe at a free end thereof;
a Z-scanning actuator that scans the cantilever along the Z-axis, and
a follow-up control controller that controls the objective lens driving actuator so that the objective lens is driven to follow the scanning of the cantilever along the. Z-axis.

12. The compound microscope according to claim 11, wherein the follow-up control controller controls the objective lens driving actuator based on a scanning signal supplied to the Z-scanning actuator.

13. The compound microscope according to claim 11, wherein the Z-scanning actuator includes a Z-piezoelectric element that finely moves the cantilever along the Z-axis and a Z-coarse adjustment actuator that coarsely moves the cantilever along the Z-axis.

14. The compound microscope according to claim 11, comprising a controller that overlays the sample surface layer information and fluorescent information, and a monitor that displays an image in which the sample surface layer information. and the fluorescent information are overlaid.

15. The compound microscope according to claim 11, wherein the inverted optical microscope is one of a confocal microscope and a super-resolution microscope.
